(19) United States
(12) Patent Application Publication
(10) Pub. No.: US 2024/0001549 A1
(43) Pub. Date: Jan. 4, 2024

(54) DYNAMIC PROGRAMMING AIDS FOR PROGRAMMING WORKCELL ELEMENTS

(71) Applicant: Intrinsic Innovation LLC, Mountain View, CA (US)

(72) Inventors: Tim Niemueller, Gauting (DE); Juergen Sturm, Munich (DE)

(21) Appl. No.: 17/855,037

(22) Filed: Jun. 30, 2022

(51) Int. Cl. B25J 9/16

(52) U.S. Cl. CPC B25J 9/1656; B25J 9/1682; B25J 9/1602; G05B 2219/39001; G05B 2219/40397

(57) ABSTRACT

Methods, systems, and apparatus, including medium-encoded computer program products, for dynamic programming aids for programming workcell elements. An interactive robotic development system can issue commands to activate workcell elements. Each workcell element can have one or more preconfigured capabilities. A workcell element can be queried and at least one preconfigured capability can be obtained that represents an action that can be performed by the workcell element. A first user input in an interactive programming environment that creates a program element representing a workcell entity can be received. For the program element, corresponding program components can be determined. User input acting on the program element can be received, and the user input can indicate a selected program component. Within the interactive programming environment, an interactive user interface element that displays a capability pair that includes the program element and the corresponding program component can be generated.

### BACKGROUND

This specification relates to programming robots using an interactive robot development system, such as an integrated development environment (IDE), that interacts dynamically with the robots. An IDE is software for building applications that integrates capabilities into a single development tool.

### SUMMARY

This specification describes technologies relating to programming robots. An interactive robot development system can dynamically query robots being programmed to determine capabilities of the robot. After discovering such capabilities, which can be specific to a robot, or to a type of robot, the interactive robot development system integrates the capabilities into the object descriptions of the robots possessing the capabilities.

Particular embodiments of the subject matter described in this specification can be implemented so as to realize one or more of the following advantages. The techniques described below can be used to simplify the programming of robot systems, including interactive programming. When a user references an object associated with a robot, the system can present the list of preconfigured capabilities and/or list list of available workcell elements. Further, the techniques can provide more flexibility since the techniques retrieve the lists of capabilities and workcell elements dynamically. Therefore, when capabilities or workcell elements are added, the system can present a complete and accurate list, even if capabilities or workcell elements are added during the program's lifecycle. In addition, such dynamic operation facilitates collaboration among skill developers, who can create and provide a rich set of preconfigured capabilities, and robot programmers, who leverage the preconfigured capabilities, which are loaded dynamically and as needed, simplifying the task of programming robots. The technique can further improve the use of system resources by retrieving the list of capabilities and/or workcell elements only when the list is required, eliminating unnecessary network traffic.

One aspect features an interactive robotic development system issuing respective commands to activate one or more workcell elements in a robot workcell. Each workcell element can have one or more preconfigured capabilities. An interactive programming environment for controlling the workcell elements in the robot workcell can be executed. A workcell element can be queried and at least one preconfigured capability can be obtained. The preconfigured capabilities can represent an action that can be performed by the workcell element. A first user input in the interactive programming environment that creates a program element representing a workcell entity can be received. For the program element, corresponding program components can be determined. The program element and each program component can represent a capability pair that includes the workcell element and a preconfigured capability of the workcell element. User input acting on the program element can be received, and the user input can indicate a selected program component. Within the interactive programming environment, an interactive user interface element that displays a capability pair that includes the program element and the corresponding program component can be generated.

One or more of the following features can be included. The workcell entity can be a robot and the interactive user interface element can display preconfigured capabilities of the robot. The workcell entity can be a preconfigured capability and the interactive user interface element can display one or more robots having the preconfigured capability. A second user input in the interactive programming environment can be received, and in response, program code can be autogenerating, and when executed, the program code can cause the robot to perform the preconfigured capability. Querying the workcell element can occur after receiving the user input creating the program element. Querying the workcell element can occur before receiving the user input creating the program element. Querying the workcell element can include accessing a capability registry for the workcell element. A previous query time can be provided to the capability registry, and a set of preconfigured capabilities added to the capability registry after the previous query time can be received from the capabilities registry. The workcell entity can be at least one of a controller, an item acted upon by a robot or a target location.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example environment for interactive robot development.

FIG. 2 shows a process for interactive robot development.

FIGS. 3A-3D show an example user interface for an interactive robot development system.

FIG. 4 is a block diagram of an example computer system 400 that can be used to perform operations described above.

### DETAILED DESCRIPTION

Robotics control refers to controlling the physical movements of robots and other automation equipment (such as grippers, conveyor belts or sensors) in order to perform tasks. For example, an industrial robot that builds cars can be programmed to first pick up a car part and then weld the car part onto the frame of the car. Each of these actions can themselves include dozens or hundreds of individual movements by robot motors and actuators.

To simplify programming, robots can have numerous capabilities, and a capability can involve performing one or more tasks, each of which can include subtasks. For example, a connector insertion task is a capability that enables a robot to insert a wire connector into a socket. This task typically includes two subtasks: 1) move a tool of a robot to a location of the socket, and 2) insert the connector into the socket at the particular location.

In this specification, a subtask is an operation to be performed by a robot using a tool. For brevity, when a robot has only one tool, a subtask can be described as an operation to be performed by the robot as a whole. Example subtasks include welding, glue dispensing, part positioning, and surface sanding, to name just a few examples. Subtasks are generally associated with a type that indicates the tool required to perform the subtask, as well as a location within a coordinate system of a workcell at which the subtask will be performed.

Robots can be preconfigured with a set of capabilities, and such capabilities can be made immediately available to robot programmers. To preconfigure the capabilities on a robot, in some instances, an administrator (e.g., a workcell administrator) can install capabilities on a robot. Similarly, in some instances, a robot can download capabilities from a capabilities registry. Once a capability is loaded on a robot, the robot becomes preconfigured for the capability and can perform the functions defined by the capability.

In addition, robot programmers can create additional capabilities by writing programs that combine existing capabilities into a new capability. Programmers can then use such additional capabilities when programming a robot.

Programmers commonly use integrated development environments (IDEs) to simplify programming tasks. IDEs can provide a single user interface that enables programmers to write, compile and execute code. In addition, many IDEs also allow programmers to include reusable code packages provided by other programmers. For example, packages such as TensorFlow simplify the training and use of machine learning models. Once an IDE has loaded a package, the programmer has access to the capabilities provided by the package.

However, such static packages are of limited use when programming robots that exist in a robot workcell. When developing code for robot workcells, developers must access capabilities of the robots that currently exist in a workcell, and the capabilities can depend not only on the type of robot, but also on the make and model. In addition, robot capabilities can be added over time, so any static listing of capabilities can quickly become stale. Thus, a need exists to dynamically discover the capabilities of robots that exist in a workcell, and to integrate those capabilities into an interactive robot development system, which can take the form of an IDE.

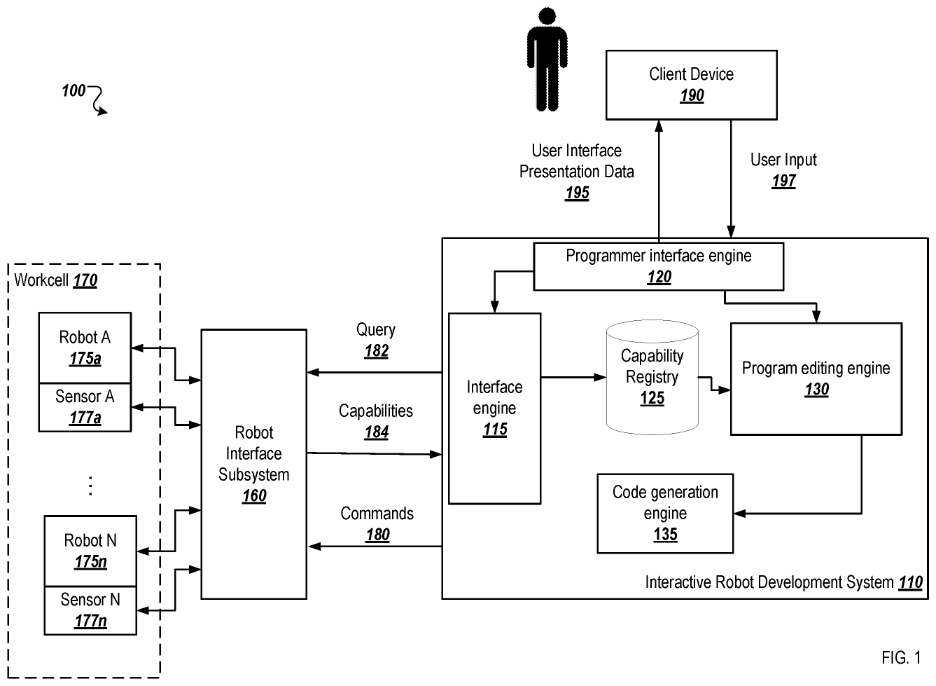

FIG. 1 shows an example environment 100 for interactive robot development. The environment 100 can include one or more workcells 170, one or more robot interface subsystems 160, an interactive robot development system 110 and one or more client devices 190.

A workcell 170 can be a system that includes one or more workcell elements, which can include robots, controllers, items acted upon by robots (e.g., parts to be assembled), target locations (e.g., where a part is to be inserted), other peripherals such as part positioners, among other elements that can be present in a workcell. A workcell 170 can be a physical workcell that contains robots or a virtual workcell that simulates a physical workcell and includes virtual robots that simulate the behavior of corresponding physical robots.

Each robot 175a, 175n (collectively referred to as 175) in a workcell 170 is a machine that is configured to perform tasks. As described above, robots can perform a wide variety of tasks, from moving items from one location to another to assembling items during manufacturing. In addition, many robots are capable of changing position. For example, some robot arm can move in three-dimensions. Some robots include locomotion and can change their position in space. Robots have built-in capabilities, which can be relatively simple (e.g., rotate arm N degrees) or quite complex (e.g., insert screw into slot).

Each robot 175 can include or be coupled to one or more sensors 177a, 177n (collectively referred to as 177). Sensors 177 can detect a wide range of properties such as location, distance, heat, pressure, and many more. Sensors 177 can enable robots 175 to exercise their capabilities. For example, to insert a screw, a robot 175 might use a camera sensor 177 to locate a pre-drilled screw hole and use the location to position the screw. As noted above, robots 175 and sensors 177 can be physical objects, or virtual representations of their physical counterparts. Because a workcell 170 can include numerous sensors, and robots can include multiple actuators, robot environments are highly complex. Therefore, techniques that simplify the use of robots, such as the techniques described in this specification, are beneficial to robot programmers.

A workcell 170 can interact with other components in the environment 100 through the robot interface subsystem 160. The robot interface subsystem 160 can accept commands 180, queries 182 and other instructions, and can provide capabilities 184, status and other responses. The robot interface subsystem 160 can provide an application programming interface (API) through which computer programs can interact with components of the workcell 170.

The interactive robot development system 110 can include an interface engine 115, a programmer interface engine 120, a capability registry 125, a program editing engine 130 a code generation engine 135.

The interface engine 115 can be coupled to the robot interface subsystem 160, enabling the interactive robot development system 110 to issue commands 180 and queries 182 to the workcell 170 and to receive responses, such as capabilities 184. The interface engine 110 can be coupled to the robot interface subsystem 160 over a network such as a local area network (LAN), a wide area network (WAN), the Internet, or a combination thereof.

The programmer interface engine 120 can provide user interface presentation data 195 to a client device 190 associated with a user and to receive user input 197 from the client device 190. The user interface presentation data 195 can include instructions which, when rendered by the client device 190, cause the client device 190 to display information, e.g., one or more graphical user interface elements. User input 197 can include data provided by the user through interactions with the user interface presentation data 195. For example, user input can include data (e.g., character strings, numbers, voice data, etc.), interactions (clicks, presses, swipes, etc.) and other data provided by the user.

The client device 190 is an electronic device that is capable of presenting user interface data, interacting with one or more users, creating input data, requesting and receiving message over a network, and so on. Example client devices 190 desktop computers, laptop computer, mobile devices such as tablet, etc. Note that while the client device 190 is illustrated as being separate from the interactive robot development system 110, the interactive robot development system 110 can execute on the client device 190 or on a separate computing device.

The capability registry 125 can store capabilities 184 of robots 175 and other workcell elements present in a workcell 170. The capability registry can also store metadata about the capabilities, such as a time a capability was added or modified. In some implementations, the capability registry can store a time of last modification of any capability for a robot type. (The type of a robot can be defined by any combination of make, model, object name, manufacturer and other descriptive data about the robot.)

A capability 184 can include information about the robot 175 (e.g., make, model, identifier, description, etc.) and information about the capability 184, which can include the capability name. A capability 184 can also include a reference to an implementation of the capability (e.g., a Uniform Resource Identifier (URL) that points to a resource containing robot instructions) and/or an implementation. There can be multiple capabilities that reference the same robot (e.g., by an identifier, make, model, etc.), allowing multiple skill developers to provide capabilities either independently or collaboratively. A capability can result in a robot performing a task or a subtask. In addition, as noted above, implementations of capabilities can make use of other capabilities, which themselves can implement tasks or subtasks. Therefore, complex capabilities can be built using other capabilities, which can be provided by any skill developer.

A capability can be encoded in any suitable format. In some implementations, multiple capabilities of a robot (or robot type) can be encoded as Extensible Markup Language (XML) where elements of the XML represent metadata about the robot and a list of the capabilities. An example format is shown in Listing 1, below.

Listing 1

```
<CAPABILITIES>
  <WORKCELL-ELEMENT-TYPE> ROBOT </WORKCELL-ELEMENT-TYPE>
  <WORKCELL-ELEMENT--ID> ... </WORKCELL-ELEMENT-_ID>
  <WORKCELL-ELEMENT-MAKE> ... </WORKCELL-ELEMENT-MAKE>
  <WORKCELL-ELEMENT-MODEL> ... </WORKCELL-ELEMET-MODEL>
  <WORKCELL-ELEMENT-OBJECT_NAME> ... <WORKCELL-ELEMENT-
OBJECT_NAME>
  <WORKCELL-ELEMENT-MANUFACTURER> ... </WORKCELL-ELEMENT-
_MANUFACTURER>
  <CAPABILITY>
    <NAME> POWER_ON </NAME>
    <IMPLEMENTATION>
        https://www.example.com/capabilities/PowerOn
    </IMPLEMENTATION>
  </CAPABILITY>
  <CAPABILITY>
    <NAME> INSERT_SCREW </NAME>
      <IMPLEMENTATION>
        https://www.example.com/capabilities/InsertScrew
    </IMPLEMENTATION>
  </CAPABILITY>
  <CAPABILITY>
      <NAME> REMOVE_SCREW </NAME>
      <IMPLEMENTATION>
          https://www.example.com/capabilities/RemoveScrew
      </IMPLEMENTATION>
  </CAPABILITY>
  <CAPABILITY>
      <NAME> POWER_OFF </NAME>
      <IMPLEMENTATION>
          https://www.example.com/capabilities/PowerOff
      </IMPLEMENTATION>
  </CAPABILITY>
```

The capability registry 125 can be stored on any conventional data storage mechanism such as a relational database or an object database. Note that while the capability registry 125 is shown inside the interactive robot development system 110, the capability registry 125 can exist on a computing device that is remote from the other components and connected via cable or network. For example, in some implementations, the capability registry 125 can be a component of the robot interface subsystem 160. In some examples, the capability registry can be replicated or distributed across multiple components of the environment, such as the interactive robot development system 110, the robot interface subsystem 160 or across other components such as remote databases.

The program editing engine 130 can provide editing, compiling, debugging, execution and other functions conventionally included in an IDE. The program editing engine 130 can produce user interface presentation data 195 that enables a client device 190 to interact with a robot program, and can accept user input 197 that causes program editing engine 130 to the state of the robot program to act upon the robot program. Such actions can include altering the robot program (e.g., adding, modifying or deleting all or part of the program), compiling the program, error checking the program, causing execution of the program (e.g., by transmitting commands through the robot interface subsystem 160) and so on.

The program editing engine 130 can retrieve capabilities 184 from the capability registry 125, which enables the program editing engine 130 to provide user interface presentation data 195 that includes descriptions of capabilities and methods related to the capabilities. For example, if a client device provides user input 197 indicating that a robot program is instantiating a robot object of “RobotType1,” and robots of RobotType1 have an “insert screw” capability, in response to receiving the user input, 197 the program editing engine 130 can retrieve the insert screw capability 184

The code generation engine 135 can convert a robot program into instructions that can be executed by one or more robots 175 in one or more workcells 170. The code generation engine can use conventional compilation and code interpretation techniques to produce instructions that can be transmitted through the robot interface subsystem 160 to the robots 175 in a workcell 170.

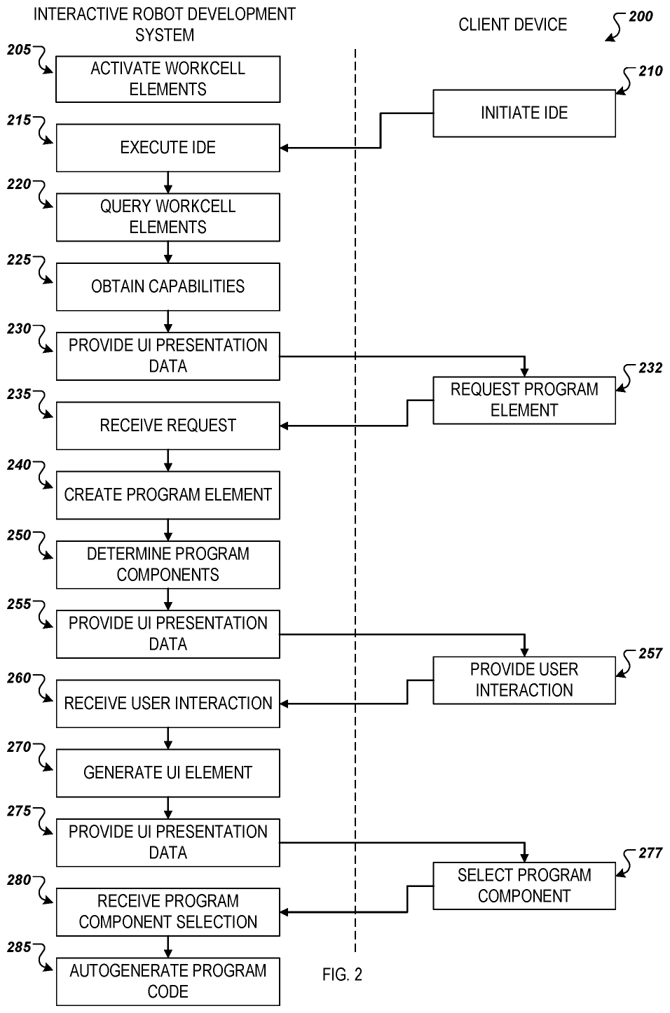

FIG. 2 shows a process 200 for interactive robot development. For convenience, the process 200 will be described as being performed by a system for interactive robot development, e.g., interactive robot development system 110 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system issues (205) commands to activate one or more workcell elements in a robot workcell, and each workcell element can have one or more preconfigured capabilities (or “capabilities” for brevity), as described further below. The system can issue the commands in response to various events, such as a client device providing user input indicating that workcell elements should be activated, a robot program indicating that workcell elements should be started, time of day (e.g., workcell elements are activated daily at 6 am), in response to a detected condition (e.g., the presence of a user), and so on. The system can issue the command by transmitting a message to a robot interface subsystem coupled to the workcell element(s).

A user provides a signal that corresponds to the initiation (210) of an interactive programming environment and the system executes (215) the interactive programming environment for controlling the one or more workcell elements in the robot workcell. In one example, a client device can send input data to the interactive programming environment signaling that the interactive programming environment should execute, and in response, the interactive programming environment can begin execution. In another example, a user can interact with a computing device on which the interactive programming environment will run, causing the interactive programming environment to execute. For example, a user can double-click on an icon representing the interactive programming environment, and an operating system on the computing device can detect the double click and execute the interactive programming environment.

The system queries (220) one or more workcell elements and obtains (225) capabilities of the workcell elements. As described above, capabilities represent actions that can be performed by the workcell element. In some implementations, the system can query the workcell elements by transmitting a query to the robot interface subsystem coupled to the workcell elements, and the workcell elements can respond by providing a list of their capabilities to the robot interface subsystem, which can provide the capabilities to the system.

In some implementations, the system can query the workcell elements indirectly. The workcell elements can provide a list of their capability to a capability registry, and the system can access the capability registry to determine the capabilities. For example, if the capability registry is a relational database, the system can access the capabilities registry by issuing Structured Query Language (SQL) calls to the capabilities registry to retrieve the capabilities for one or more workcell elements.

Once received, the system can store the capabilities in memory. For example, the system can store the capabilities in a hash table where the hash table key includes any combination of the workcell element object name, the workcell element make and the workcell element model. In another example, the system can store the capabilities in a database table, where each capability is stored in a row of the table, and each element of the capability is stored in a column of the table.

In some implementations, the system can query the workcell elements when the system begins operation. This technique can result in the user interface performing more responsively since the system can precache the capabilities at startup, so later queries are not required. In some implementations, the system can query the workcell elements only after receiving user input indicating the creation of a program element (as described further below), which can result in fewer network interactions since the system need only retrieve capabilities of workcell elements that are actually referenced in a program.

In some implementations, the system can cache the received list of capabilities, allowing the system to reduce interactions with the workcell elements and/or capability registry. In some implementations, the system can store an indication of the time capabilities for a workcell element were retrieved, and in response to receiving user input indication the creation of a program element, the system can access a capability registry (e.g., by issuing a query) for the time of last medication of capabilities associated with the workcell element, and if the time of last modification is more recent than the retrieval time, the system can issue a query for workcell element capabilities. In some implementations, the system query the capability registry and provide a previous query time. The capability registry can determine which preconfigured capabilities have been added to the registry after the previous query time, and provide the set of preconfigured capabilities added to the capability registry after the previous query time. The system can then receive the set of preconfigured capabilities added to the capability registry after the previous query time provided by the capability registry.

Queries for capabilities can request all capabilities or capabilities that have changed since the system last issued a query. In some implementations, queries for capabilities that have changed can include the time the system last made a query. A workcell element or capability repository can compare that time to the times at which capabilities were added, and respond only with added or updated capabilities, reducing network traffic.

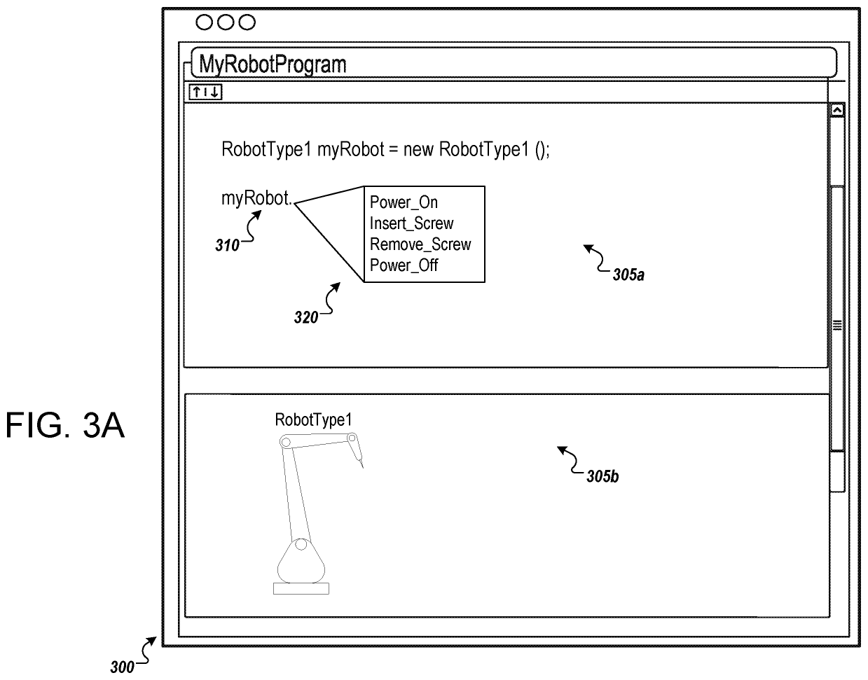

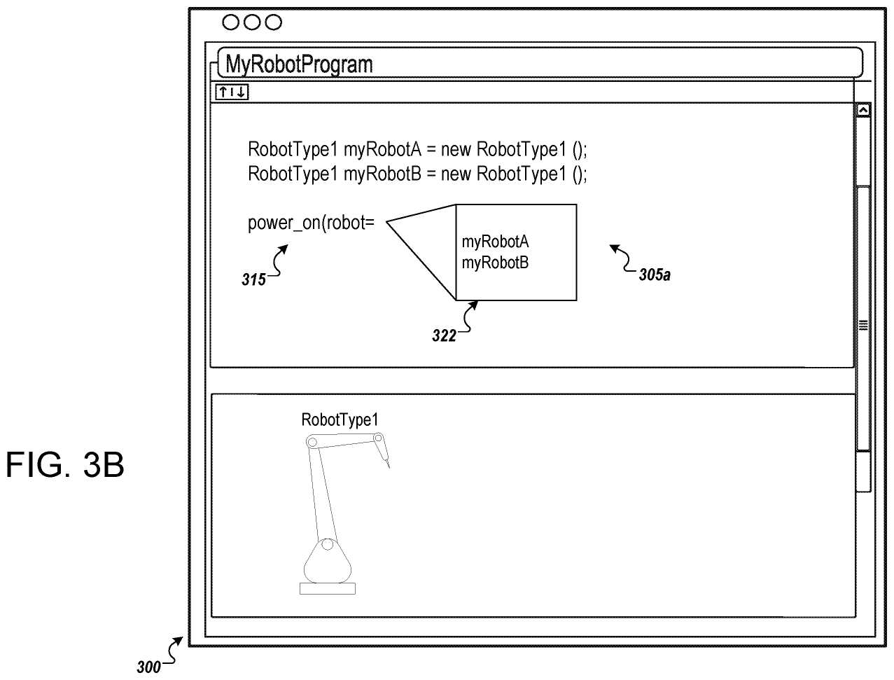

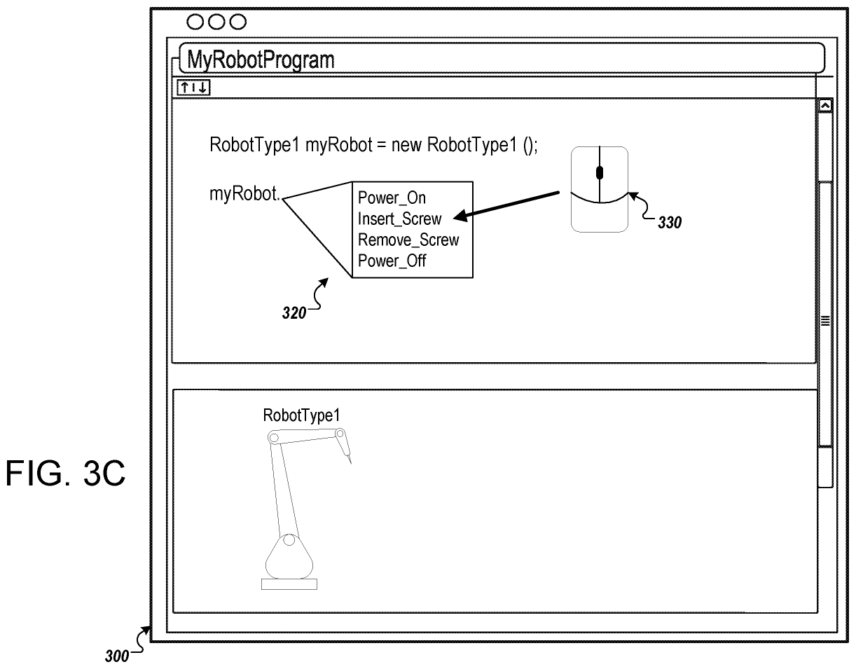

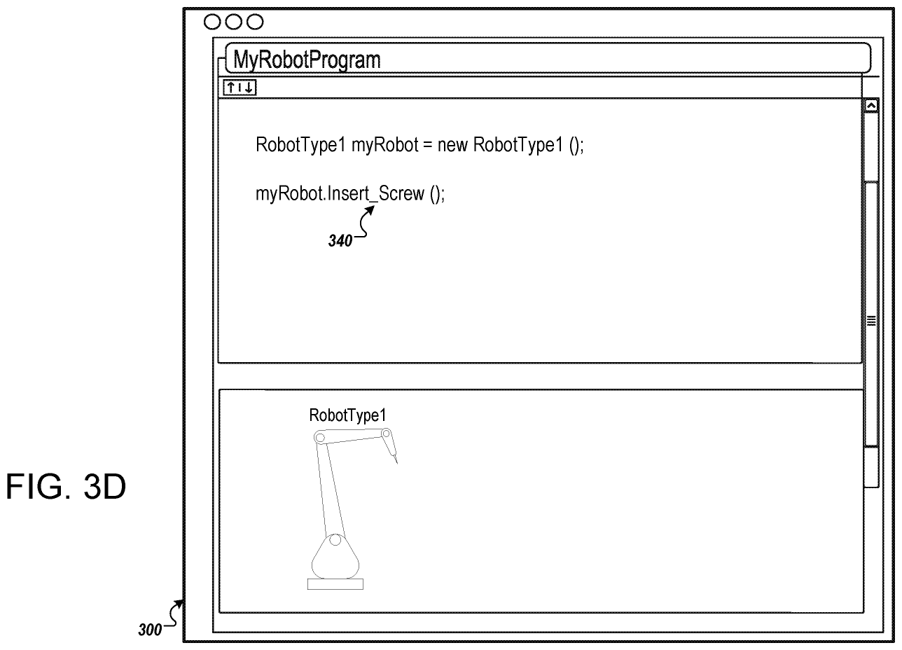

The system provides (230) user interface presentation data to the client device. In some implementations, when rendered by the client device, the user interface presentation data can cause the client device to display a user interface for a robot programming IDE, as described in more detail in reference to FIGS. 3A and 3B. In some implementations, the client device can include a preloaded IDE, and the user interface presentation data, when rendered by the client device, can cause the user interface for the IDE to include descriptions of one or more workcell elements.

In either implementation, the system can transmit the user interface presentation data to the client device over any conventional protocol such as a Transmission Control Protocol (TCP) socket, Hypertext Transfer Protocol (HTTP), Hypertext Transfer Protocol-Secure (HTTP-S), a method call (local or remote) and so on.

A user requests (232) a program element that represents a workcell entity. A workcell entity can be workcell element (e.g., a robot, controller, etc., as described above) or a preconfigured capability of a workcell element.

When the workcell entity is a workcell element, the user of a client device can interact with user interface presentation data provided by the server to create a program element that represents a workcell element. For example, the user can instantiate an object that represents the robot. An example is shown in Listing 2, below.

Listing 2

RobotType1 myRobot = new RobotType1 ( );

In this example, the user has requested a program element of robot object type ‘RobotType1,’ and has associated that program element with the variable ‘myRobot.’

In some implementations, the program element can be a capability. The user of a client device can interact with user interface presentation data provided by the server to create a program element that represents a capability. For example, the user might interact with the user interface presentation data to create an “InsertScrew” capability in the user interface.

In some implementations, when the workcell entity is a preconfigured capability, the system can provide a list of available workcell elements associated with the preconfigured capability. The system can retrieve from a capabilities registry the workcell elements that have a specified capability. For example, a user can type a capability such as “insertScrew.”, and the system can retrieve and provide a list of workcell elements for which that capability exists.

In some implementations, the system can include a set of keywords that enable a user to determine properties of a workcell. For example, a user can type a keyword (e.g., “equipment.”) and the system can retrieve and present a list of available workcell elements such as available robots, gripper, sensors, etc. The user can then select from the presented list, further simplifying robot programming.

In some implementations, the program element can be other attributes associated with a workcell. For example, the program element can be objects available in the workcell.

In response to the user requesting the program element, e.g., by instantiating the object, the client device can create input data and deliver the input data to the system and the system receives the request (235). The input data can be transmitted and received over any conventional protocol such as a TCP socket, HTTP, a method call (local or remote) and so on.

The system creates (240) a program element. The system can allocate space in memory necessary to store the program element, and store a reference to the allocated space.

The system determines (250) for the program element one or more corresponding program components. When the program element represents a workcell element, the program components can represent preconfigured capabilities of the workcell element. In some implementations, the system has previously retrieved the preconfigured capabilities for the workcell element and can determine the corresponding program components from the cached responses. For example, the system can query a local database caching the preconfigured capabilities using the object type as the search key and receive the capabilities that match the object type. Also as described above, in some implementations, the system does not retrieve the capabilities until they are requested, and the system can retrieve the capabilities before populating the set.

When the program element represents a preconfigured capability, the system can determine one or more workcell elements that implement the capability program element requested in operation 232. As described above, the system can query a registry (e.g., the capabilities registry or a separate registry) that contains a set of associations between capabilities and workcell elements that provide those capabilities, and retrieve the workcell elements associated with the requested capability.

The combinations of a program element and each program component can be called a “capability pair” that represents a workcell element and a preconfigured capability of the workcell element. For example, if a workcell element is represented by program element “myRobot” and the workcell element has a preconfigured capability named “insertScrew,” the corresponding capability pair is {“myRobot”, “insertScrew”}. A capability pair can also represent a type of workcell element and a preconfigured capability for the type of workcell element. For example if robots of “RobotType1” include preconfigured capability “extendArm,” a capability pair can be {“RobotType1”, “extendArm”}.

The system provides (255) user interface presentation data that includes descriptions of the capabilities or workcell elements associated with the requested program element to the client device. The system can transmit the user interface presentation data to the client device using the techniques of operation 230 or similar techniques.

A user provides (257) an interaction and the system receives (260) user input representing the user interaction with the program element representing the workcell element or capability. For example, the user can interact with user interface presentation data provided by the system by typing (or speaking) or selecting a reference to a program variable that represents the workcell element (e.g., myRobot). In response, the client device can create input data that describes the interaction and transmit the input data to the system, which can receive the input data. Once a program element is present in the user interface presentation data, a user interaction can be providing an indication that a program component should be added. For example, if “myRobot” is present, the user can interact by adding a “.” character (or alternate indicator such as “->”) indicating that a program component representing a preconfigured capability is to be added.

The system generates (270), within the interactive programming environment, an interactive user interface element that displays a capability pair that includes the program element and the corresponding program component that represent a a workcell element and a preconfigured capability of the workcell element, The system can create user interface presentation data that includes a description of the capabilities of the workcell element or the set of workcell elements, and that when rendered by a client device, causes the device to display the capabilities or workcell elements, e.g., as shown in FIGS. 3A-3D. The system provides (275) the created user interface presentation data to the client device. The system can transmit the user interface presentation data to the client device using the techniques of operation 230 or similar techniques.

FIG. 3A shows an example user interface 300 for an interactive robot development system. The user interface 300 can be displayed by a client device in response to receiving user interface presentation data from the system. The user interface 300 can contain multiple panels 305a, 305b. Panel 305a is a program editing widget in which a user has typed ‘myRobot.’ 310. In response, the system retrieves and displays a user interface element 320 that includes the capabilities associated with the robot type (RobotType1) for the variable (myRobot). As described above, these capabilities can be retrieved from workcell elements that are available in a physical or virtual workcell, or indirectly by issuing a query (e.g., an SQL query) to access a capability registry.

FIG. 3B shows an example user interface 300 for an interactive robot development system. Panel 305a again is a program editing widget, and in this example, a user has specified the capability “power_on” 315. In response, the system retrieves and displays a user interface element 322 that includes the workcell elements that include the specified “power_on” capability. The user interface element 322 includes the two instantiated objects myRobotA and myRobotB, both of which include the “power_on” capability. The interactive robot development system of this specification can include both cases—i.e., (i) the user specifies a workcell element, and the system retrieves the associated capabilities, and (ii) the user specifies a capability, and the system retrieves the objects that include the capability—and in any combination.

A user can select (277) a program component, which can be a preconfigured capability or a workcell element, as described above. In some examples, the user can select the program component by interacting with user interface presentation data provided by the server, for example, using a pointing device such as a mouse or stylus. The client device can receive an event indicating the interaction with the user interface presentation data, and create input data that includes an indication of the program component.

FIG. 3C shows the user interface 300 that is displaying capabilities 320 associated with the object, and continues the example of FIG. 3A. A user can select one of the capabilities 320 using a pointing device such as a mouse 330.

The client device can transmit the input data that includes an indication of the program component, and the system can receive (280) the input data. In response, the system can autogenerate (285) program code that when executed causes the robot to perform the preconfigured capability.

FIG. 3D shows the user interface 300 after the selection of a capability. The user interface can be displayed on the client device in response to receiving user interface presentation data provided by the system. In this example, it shows the generation of a method call 340 to an ‘Insert Screw’ capability on the myRobot object.

In some implementations, the system can translate the program code (e.g., code 340 of FIG. 3C) into robot-specific program code. The system can use conventional compilation techniques to perform the translation.

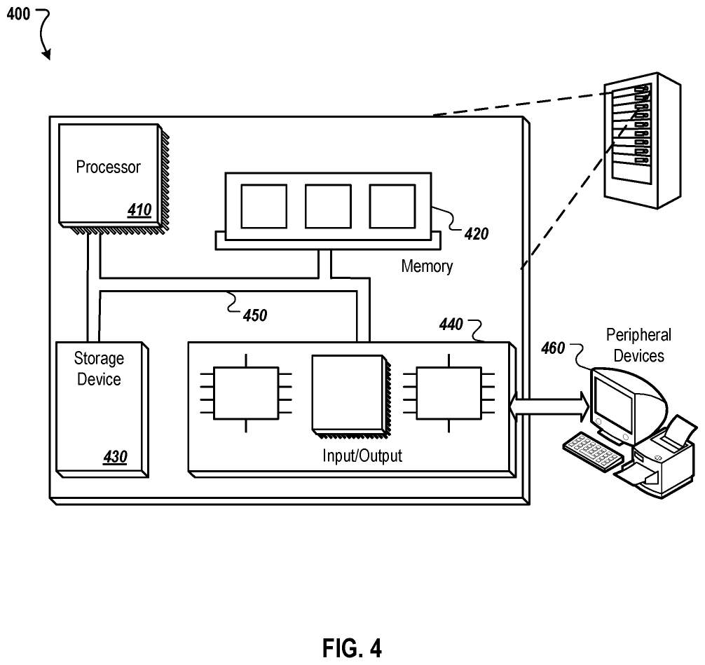

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-242 port, and/or a wireless interface device, e.g., and 802.11 card. In another implementation, the input/output device can include driver devices configured to receive input data and send output data to other input/output devices, e.g., keyboard, printer and display devices 470. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
issuing, by an interactive robotic development system, respective commands to activate one or more workcell elements in a robot workcell, wherein each workcell element has one or more preconfigured capabilities;
executing an interactive programming environment for controlling the one or more workcell elements in the workcell;
querying a workcell element of the one or more workcell elements and obtaining at least one preconfigured capability, wherein the at least one preconfigured capability represents an action that can be performed by the workcell element;
receiving a first user input in the interactive programming environment creating a program element representing a workcell entity;
determining, for the program element, one or more corresponding program components, wherein the program element and each program component represent a capability pair comprising the workcell element and a preconfigured capability of the workcell element;
receiving user input acting on the program element, wherein the user input indicates a selected program component; and
generating, within the interactive programming environment, an interactive user interface element that displays a capability pair comprising the program element and the corresponding program component.

2. The method of claim 1, wherein the workcell entity is a robot and the interactive user interface element displays preconfigured capabilities of the robot.

3. The method of claim 1, wherein the workcell entity is a preconfigured capability and the interactive user interface element displays one or more robots having the preconfigured capability.

4. The method of claim 2, further comprising:
receiving a second user input in the interactive programming environment; and
in response, autogenerating program code that when executed causes the robot to perform the preconfigured capability.

5. The method of claim 1, wherein querying the workcell element occurs after receiving the user input creating the program element.

6. The method of claim 1, wherein querying the workcell element occurs before receiving the user input creating the program element.

7. The method of claim 1, wherein querying the workcell element comprises accessing a capability registry of capabilities for the workcell element.

8. The method of claim 7, further comprising:
providing, to the capability registry, a previous query time; and
receiving, from the capability registry, a set of preconfigured capabilities added to the capability registry after the previous query time.

9. The method of claim 1, wherein the workcell entity is at least one of a controller, an item acted upon by a robot or a target location.

10. A system comprising one or more computers and one or more storage devices storing instructions that when executed by the one or more computers cause the one or more computers to perform operations comprising:
issuing, by an interactive robotic development system, respective commands to activate one or more workcell elements in a robot workcell, wherein each workcell element has one or more preconfigured capabilities;
executing an interactive programming environment for controlling the one or more workcell elements in the robot workcell;
querying a workcell element of the one or more workcell elements and obtaining at least one preconfigured capability, wherein the at least one preconfigured capability represents an action that can be performed by the workcell element;
receiving a first user input in the interactive programming environment creating a program element representing a workcell entity;
determining, for the program element, one or more corresponding program components, wherein the program element and each program component represent a capability pair comprising the workcell element and a preconfigured capability of the workcell element;
receiving user input acting on the program element, wherein the user input indicates a selected program component; and
generating, within the interactive programming environment, an interactive user interface element that displays a capability pair comprising the program element and the corresponding program component.

11. The system of claim 10, wherein the workcell entity is a robot and the interactive user interface element displays preconfigured capabilities of the robot.

12. The system of claim 10, wherein the workcell entity is a preconfigured capability and the interactive user interface element displays one or more robots having the preconfigured capability.

13. The system of claim 11, further comprising:
receiving a second user input in the interactive programming environment; and
in response, autogenerating program code that when executed causes the robot to perform the preconfigured capability.

14. The system of claim 10, wherein querying the workcell element occurs after receiving the user input creating the program element.

15. The system of claim 10, wherein querying the workcell element occurs before receiving the user input creating the program element.

16. The system of claim 10, wherein querying the workcell element comprises accessing a capability registry of capabilities for the workcell element.

17. The system of claim 16, further comprising:
providing, to the capability registry, a previous query time; and
receiving, from the capability registry, a set of preconfigured capabilities added to the capability registry after the previous query time.

18. The system of claim 10, wherein the workcell entity is at least one of a controller, an item acted upon by a robot or a target location.

19. One or more non-transitory computer-readable storage media storing instructions that when executed by one or more computers cause the one or more computers to perform operations comprising:
issuing, by an interactive robotic development system, respective commands to activate one or more workcell elements in a robot workcell, wherein each workcell element has one or more preconfigured capabilities;
executing an interactive programming environment for controlling the one or more workcell elements in the robot workcell;
querying a workcell element of the one or more workcell elements and obtaining at least one preconfigured capability, wherein the at least one preconfigured capability represents an action that can be performed by the workcell element;
receiving a first user input in the interactive programming environment creating a program element representing a workcell entity;
determining, for the program element, one or more corresponding program components, wherein the program element and each program component represent a capability pair comprising the workcell element and a preconfigured capability of the workcell element;
receiving user input acting on the program element, wherein the user input indicates a selected program component; and
generating, within the interactive programming environment, an interactive user interface element that displays a capability pair comprising the program element and the corresponding program component.

20. The one or more non-transitory computer-readable storage media of claim 19, wherein the workcell entity is a robot and the interactive user interface element displays preconfigured capabilities of the robot.
